(19) United States
(12) Patent Application Publication
(10) Pub. No.: US 2007/0261563 A1
(43) Pub. Date: Nov. 15, 2007

(54) AUTOMATIC DISPENSER OF BREWED BEVERAGES

(75) Inventors: Gilles MORIN, Sainte Honorine du Fay (FR); Severine Mih, Mayenne (FR); Thierry Dutertre, Saint Germain du Corbeis (FR)

Correspondence Address: BROWDY AND NEIMARK, P.L.L.C.;624 NINTH STREET, NW, SUITE 300, WASHINGTON, DC, 20001-5303, US

(73) Assignee: SEB S.A., Ecully (FR)

(21) Appl. No.: 11/746,231

(22) Filed: May 9, 2007

(30) Foreign Application Priority Data
May 9, 2006 (FR) FR-0604088

(51) Int. Cl. A47J 31/00

(52) U.S. Cl. 99/279

(57) ABSTRACT

An automatic dispenser for brewing beverages from a product in granular form, composed of: a brewing chamber; a device for dispensing the product in granular form, having a dispensing opening and a chute communicating with the dispensing opening, the chute being adapted to channel the product towards the brewing chamber; and an automatic device for cleaning the chute. The automatic device for cleaning includes a wiping arm disposed within the chute and an electric drive mechanism connected for imparting a cleaning movement to the wiping arm.

### BACKGROUND OF THE INVENTION

The present invention relates to an appliance of the type used for automatically distributing, or dispensing, brewed beverages starting from a device for dispensing powdered, or ground, or granular food products for brewing or percolation, such as ground coffee, tea, chocolate, etc.

An appliance for preparing and dispensing hot beverages generally comprises a cold water reservoir, an electric pump, a boiler and a brewing head adapted to receive the product in powdered or ground form in order to inject therein hot water coming from the boiler, the resulting brewed beverage then being then directed towards a collecting receptacle, such as a cup. At the end of the brewing cycle, the brewing head must be opened in order to be able to introduce a new amount of brewing product after having evacuated the remainder of product previously used for brewing.

Such an appliance is described in the patent document WO99/12457, the disclosure of which is incorporated herein by reference, and relates to an appliance adapted to dispense in an automatic way espresso coffee starting from coffee grounds. The appliance comprises a brewing group comprising a brewing chamber having a vertical axis and adapted to receive a pressing piston mounted for sliding movement along said vertical axis actuated by the piston of a hydraulic actuating cylinder, or jack. The piston of the hydraulic actuating cylinder is connected to the pressing piston and can pass from a home position to a work position in which the pressing piston compresses, or tamps, the grounds in the brewing chamber under the effect of the pressurized hydraulic fluid. Passage to the home position is effected by the action of a return spring.

This appliance in addition comprises an automatic dispenser of ground coffee comprising a reservoir containing the grounds, provided with a dispensing opening, a chute leading the grounds towards the brewing chamber, as well as a hub connected to a shaft that rotates the blades of the hub to force a certain quantity of the grounds into said chute via the dispensing opening during rotation of the shaft. Such an automatic dispenser of ground coffee is described in the patent document FR 2 713 906, the disclosure of which is incorporated herein by reference.

During operation of an automatic coffee maker, it has nevertheless been noted that coffee grounds accumulate in clumps or agglomerations in the chute leading the grounds from the granular product dispenser towards the brewing chamber. In effect, after brewing successive quantities of coffee, the brewing chamber releases moisture in the form of vapor, or steam. The chute for delivering coffee to the brewing chamber being located in proximity to the brewing chamber, steam emitted from the brewing chamber comes to condense on the walls of the chute, these damp walls then aiding the clumping of the coffee grounds. The coffee accumulates thus on the walls of the delivery chute of the granular product dispenser with the result that, after several coffee brewing cycles, coffee grounds can accumulate between the granular product dispenser and the brewing chamber, which accumulation is all the more pronounced when the coffee grounds are fine, as is the case when making espresso.

There are known manual devices for cleaning the chute, for example using a brush, but these devices require the intervention of the user.

In addition, the patent document EP 1 654 968, the disclosure of which is incorporated herein by reference, describes an automatic coffee maker comprising a device for automatic cleaning of the delivery chute of a ground coffee dispenser. This machine comprises a brewing assembly comprising a brewing chamber fixed at the top of a thermal block that ensures the supply of hot water to the brewing chamber. The brewing chamber receives a pressing piston that is vertically slidable inside the brewing chamber to compact, or tamp, the grounds. The pressing piston is driven by a hydraulic actuating cylinder. The machine also comprises a ground coffee dispenser provided with a chute for transfer of the ground coffee towards the brewing chamber, which chute is cleaned by a cleaning device fixed to the pressing piston. This cleaning device comprises, for this purpose, a rigid scraper cooperating with a pivotable chute, or a flexible brush coming in contact with the internal wall from the chute, the scraper or the brush being thus driven in movement by the pressing piston. Functioning satisfactorily, the movement of the scraper or brush, however, is limited to that of the piston, which movement occurs once per brewing cycle in the length direction of the chute. In addition, the particles of coffee grounds scraped after the closing of the brewing chamber by the piston accumulate on the piston or around the brewing chamber, which requires a periodic cleaning of the interior of the machine.

### BRIEF SUMMARY OF INVENTION

This invention serves to overcome the above mentioned disadvantages and provides an automatic brewed beverage dispenser comprising a dispenser of product in granular form adapted to prevent, automatically and efficiently, the accumulations of the product to be brewed on the chute leading to the brewing chamber.

The invention further provides an automatic dispenser of brewed beverages adapted to prepare a beverage of good quality, with a fresh taste, while being sure and reliable in operation.

The invention further provides an automatic brewed beverage dispenser comprising an automatic device for cleaning the coffee grounds delivery chute, which acts simultaneously with the passing of the coffee onto the chute.

The invention also provides an automatic brewed beverage dispenser comprising an automatic device for cleaning the ground coffee delivery chute, which can be manufacture economically, while being separate from the brewing assembly.

For these purposes, an automatic dispenser for brewed beverages made from a product in granular form according to the invention comprises:

a brewing chamber,

a device for distributing the product in granular form having a dispensing opening communicating with a chute adapted to channel said product towards the brewing chamber, and

an automatic device for cleaning the chute, wherein the automatic device for cleaning the chute comprises a wiping arm disposed within the chute and actuated by an electric drive mechanism.

As used herein, the term “granular” encompasses products in powder or ground form.

The dispenser of the granular product can be of the type comprising a reservoir that contains the granular product to be brewed and at the interior of which there is provided a hub carrying blades adapted to pass a certain quantity of the product through a dispensing opening and onto a chute that conveys the product to the brewing chamber. Such a granular product dispenser can also be a coffee bean grinder or mill that sends directly, through the dispensing opening, or via a buffer chamber, a certain quantity of coffee into the chute, which transfers the ground coffee into the brewing chamber. Such a chute is a tubular open or closed conduit, which is disposed generally vertically or is inclined with respect to the brewing chamber, so that the product in granular form falls by gravity into the brewing chamber.

More particularly according to the invention, the chute of the granular product dispenser is cleaned automatically by a wiping arm of an automatic cleaning device driven by electromechanical means. Electromechanical means are here intended to comprise electric drive means, such as a motor or an electromagnet, for driving a mechanism coupled with the wiping arm. Such a mechanism then comprises an arrangement of elements capable of converting mechanical energy received, as the input, from the motor shaft or an armature of the electromagnet into a movement of the wiping arm inside the chute, as the output.

This solution has the advantage of functioning automatically and independently of the other components of the appliance, by employing a simple control for supplying power to electromechanical means that actuate the wiping arm. This control can be carried out manually by the user before or after a brewing cycle or it can be preprogrammed in the logic circuit of the beverage dispenser, such circuit being part of an electronic circuit card for controlling the operation of the appliance.

Thus, due to its automatic and independent operation, the operating parameters of the movement of the wiping arm can easily be regulated or chosen by the user, for example as a function of the quantity of distributed product, the fineness of the grounds, etc.

Preferably, the electromechanical drive means comprises an electric motor and a driving mechanism adapted to transform the rotary movement of the output shaft of the motor into a reciprocating motion of the wiping arm.

Use could be made, for example, of a paddle wheel rotated by a motor, each paddle blade then constituting a wiping arm, the arms being brought in succession, during rotation of the wheel, into contact with the bottom wall of the chute. It is preferred, however, to use a driving mechanism, for example of the crank connecting rod type, permitting rotary movement of the shaft of the motor to be transformed into an alternating linear motion of the wiping arm because one can obtain, with a device of simplified structure, a fuller movement for sweeping of the walls of the chute.

Advantageously, said electric motor forms a component of the device for dispensing product in granular form.

Thus, the fact of using the same motor to drive at the same time the dispenser of product in granular form and the device for cleaning the chute proves to be a very economical solution that takes up less space, making it possible to build a beverage dispenser that is compact and of simplified structure. In addition, by operating the device for cleaning the chute at the same time as the dispenser of product in granular form, it is possible to prevent agglomeration of granular product in the chute at the time of passage of the dispensed product towards the brewing chamber and, at the same time, to maintain the chute always clean, while employing a simple, reliable and inexpensive solution.

Preferably, the driving mechanism comprises a cam rotated by the electric motor via a gear assembly. One could use other mechanisms for driving the wiping arm such as, for example, a mechanism utilizing a driving in rotation of an eccentric fixed to the rotary shaft brought to slide in a slot of an articulated toothed circular sector, itself, with a drive pinion that pivots the wiping arm. It is preferred, however, for reasons of structural simplicity, to use a rotary cam whose contour makes it possible to transform the rotational movement of the motor into an oscillating movement of the wiping arm, the gear assembly then making it possible to reduce the rotational speed, while ensuring a good transmission coupling, or torque, of force to the cam and thus to the wiping arm. Preferably, the motor reducer also serves, like the electric motor previously described, to drive the dispenser of product in granular form, for example for the setting in rotation of the burrs of a mill or the blades of a device for delivering a measured quantity, or dose, of granular product.

Advantageously, the cam drives the wiping arm in a reciprocating motion in contact with at least one wall of the chute.

The wiping arm is thus brought to perform an oscillating movement in contact with the wall of the chute, thus acting on this wall like a windshield wiper to remove the particles of product in granular form tending to adhere to the chute.

Preferably, the wiping arm carries out at least one, and preferably three, back and forth movements, during a granular product dispensing procedure.

It has been noted, during laboratory tests, that one obtains an effective cleaning of the chute by causing the wiping arm to perform a back and forth movement towards the end of the period of dispensing the product in granular form, and a better cleaning effect by performing three back and forth movements spaced out over the duration of this period to avoid agglomeration of the product during passage along the chute.

Advantageously, the cam rotates around a vertical axis.

This allows a vertical arrangement, possibly in parallel, of the electric motor, the motor-reducer and the device for dispensing the granular product for greater compactness of the machine.

Preferably, the cam actuates a switch for controlling the operation of the dispenser device for the product in granular form.

The profile of the cam can thus actuate a switch for control of starting and/or stopping of the burrs of a coffee bean mill or the dosing blades of a ground coffee reservoir after a certain number of rotations of the cam or a fraction of one revolution of the latter.

In a preferred embodiment of the invention, said dispenser device comprises a ground coffee reservoir with a dosing device provided with blades, and the cam has means for driving the blades of the dosing device in rotation. According to another embodiment of the invention, the dispenser device comprises a coffee bean mill and the cam has means driving in rotation one of the burrs of the mill.

Advantageously, the wiping arm is fixed to a slider guided in translation in a plane perpendicular to the axis of rotation of the cam.

According to an alternative, the wiping arm is mounted to pivot around an articulation located in the vicinity of the chute, one of the ends of the wiping arm then coming in contact with the rotary cam, which imparts to the arm the pivoting movement within the chute.

It is preferred, however, to impart to the wiping arm an alternating translatory movement by using a slider guided in translation in contact with the profile of the rotary cam, this movement ensuring a better sweeping of the surface traversed by the wiping arm.

Preferably, said slider is assembled in a housing together with a return spring, the force produced by the spring being in opposition to that imparted to the slider by the cam.

This constitutes a simplified solution for the mechanism for actuation of the wiping arm, the radial protuberances of the cam imparting the forward movement to the slider, the return movement of the slider being ensured by the return spring.

Advantageously, the chute is tilted, or inclined, relative to the plane of the slider and the wiping arm follows the slope of the chute.

A tilted chute forms a sort of springboard for discharge of the ground coffee, directing the coffee toward the brewing chamber; for an effective action, the wiping arm then has the same inclination as the chute and more particularly the same inclination as the wall of the chute with which the wiping arm is likely to come in contact.

Preferably, the wiping arm carries out a translatory movement in the direction of the width of the chute.

According to one alternative, the cleaning sweep can be in the direction of the length of the chute, or of the descent of the coffee. However, it has been noted that it was more advantageous to carry out a sweeping in the direction of the width, which requires a smaller amplitude of movement of the wiping arm.

Advantageously, the wiping arm is mounted close to the dispensing opening and the amplitude of the movement carried out by the wiping arm is appreciably equal to the width of the dispensing opening.

The dispensing opening emerging directly into the chute and the wiping arm being disposed directly at the entry of the chute, this solution then allows an effective cleaning of the zone where the granular product first comes into contact with the chute, ensuring thereafter a good flow of the granular product.

Preferably, said wiping arm is constituted by a stainless steel wire.

Such a wire, in particular with a diameter smaller than 3 mm, can advantageously be used to clean off the ground coffee particles because they do not adhere to the wire. According to an alternative, a coating of a material such as polytetrafluoroethylene (PTFE) could be applied to a steel wire or the wire could be covered with an elastomer plastic, thus ensuring a better cleaning of the walls of the chute.

Advantageously, said wiping arm comes to bear in an elastic manner against the wall of the chute.

This elastic contact could be effected by the elasticity of the wiping arm itself and/or by supporting it with a spring to be in contact with the walls of the chute in order to make it possible for the wiping arm to better adapt to the contour of the walls of the chute.

According to an advantageous alternative embodiment of the invention, the dispenser device comprises a granular product reservoir mounted removably in or on a support provided with an opening for passage of the product in granular form towards the chute.

The granular product reservoir being mounted in a removable manner with respect to the frame of the dispenser, the user can then easily withdraw it for cleaning or for storage in a cool place and/or replace it by another reservoir containing a different product, or a fresh supply of product, in granular form.

Advantageously, the bottom wall of the support contains a slot for evacuation, or passage, of the product in granular form toward the chute.

The support or the removable reservoir already makes it possible to carry and guide the removable reservoir relative to the frame of the dispenser, as well as to receive at the bottom of the support the possible residual product in granular form escaping from the reservoir during operation. The slot for evacuation of the product in granular form then makes it possible to evacuate these residues towards the underlying chute, the reservoir being removed from the support, and to thus keep a clean and functional support.

### BRIEF DESCRIPTION OF DRAWINGS

FIG. 1 is a perspective view of an embodiment of a brewed beverage dispenser according to the invention.

FIG. 2 is a perspective view of one embodiment of the granular product dispenser subassembly of the dispenser of FIG. 1.

FIG. 3a is a perspective view of a lower part of the subassembly of FIG. 2, with the granular product dispenser itself removed from its support to make visible other components of the subassembly, including the device for cleaning the chute.

FIG. 3b is a top plan view showing certain elements of the structure shown in FIG. 3a.

FIG. 4 is a perspective view showing one embodiment of a device according to the invention for cleaning the chute.

FIG. 5 is a perspective view of a second embodiment of a granular product dispenser subassembly according to the invention;

FIG. 6 is a perspective view from above of the support for the reservoir in the embodiment of FIG. 5.

### DETAILED DESCRIPTION OF THE INVENTION

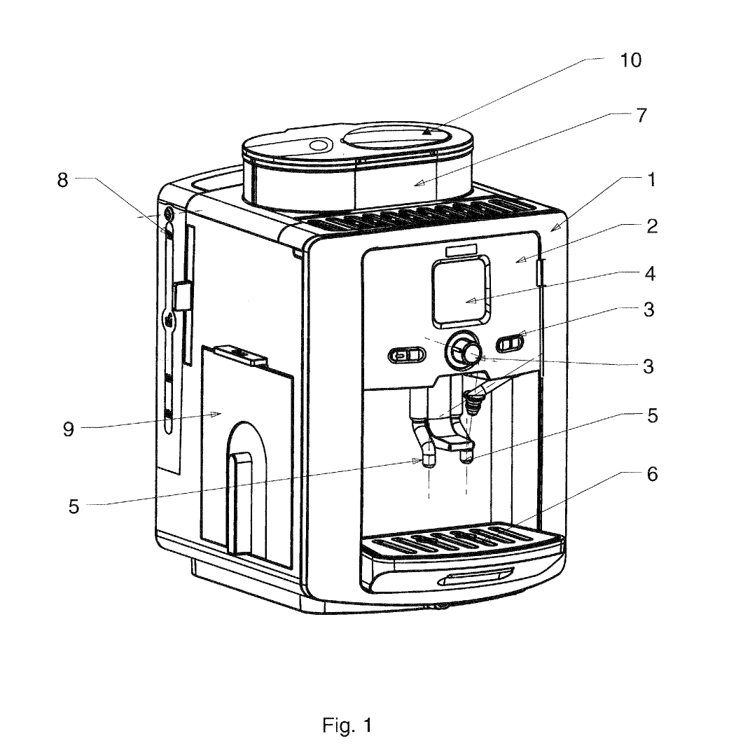

The automatic dispenser of brewed beverages represented in FIG. 1 is a coffee maker adapted to prepare espresso coffee. The coffee maker comprises a case 1 of generally parallelepiped, or cubic, form that contains the principal functional elements of the machine. Case 1 has a facade, or front face, comprising a control panel 2 made up of a series of buttons 3 acting on the electronic control circuit of the machine and a display 4. A beverage prepared by the machine flows out, or is dispensed, through two identical outlet tubes 5 of a pouring spout into a cup (not shown) placed on a support 6. The upper part 7 of case 1 encloses a dispenser 10 of granular product having, in the illustrated embodiment and as will be described hereafter, a ground coffee reservoir. A water tank, or reservoir, 8 is provided at the back part of the case. Case 1 contains, in a conventional manner, a pump and conduits for delivering water from reservoir 8 to a heating element and from there to a brewing chamber. On one of the lateral sides of the case, there is provided a vat, or container, 9 intended to receive used grounds, such as “pucks” used to make espresso, coming from the brewing chamber of the machine.

Inside case 1 there is disposed a brewing subassembly comprising a brewing chamber in the shape of a cylindrical tank adapted to receive a certain quantity of coffee grounds above a lower wall forming a filter for the grounds. The brewing chamber is mounted in a fixed manner above a thermal block, having a vertical axis, and the chamber constitutes a prolongation of the thermal block. The thermal block contains a water circuit and an electric heater and ensures a supply of hot water for the brewing chamber. The brewing chamber in addition receives a pressing piston that slides vertically and in a sealed manner in the chamber to compact, or tamp, the grounds prior to brewing. The components of the brewing subassembly are not represented in the drawings, but can be made, for example, precisely according to the description in the patent document WO 99/12456, the disclosure of which is incorporated herein by reference. The pressing piston is actuated by a hydraulic actuating cylinder to undergo its sliding movement relative to the chamber. The details of construction of a suitable hydraulic actuating cylinder and of the means for actuation of the pressing piston are described clearly in the patent document WO 99/12457, cited earlier herein. Hot water coming from the thermal block is sent through grounds in the brewing chamber and the brewed beverage is then evacuated through the pressing piston, via an internal channel of the latter prolonged by a flow conduit towards the outlet tubes 5.

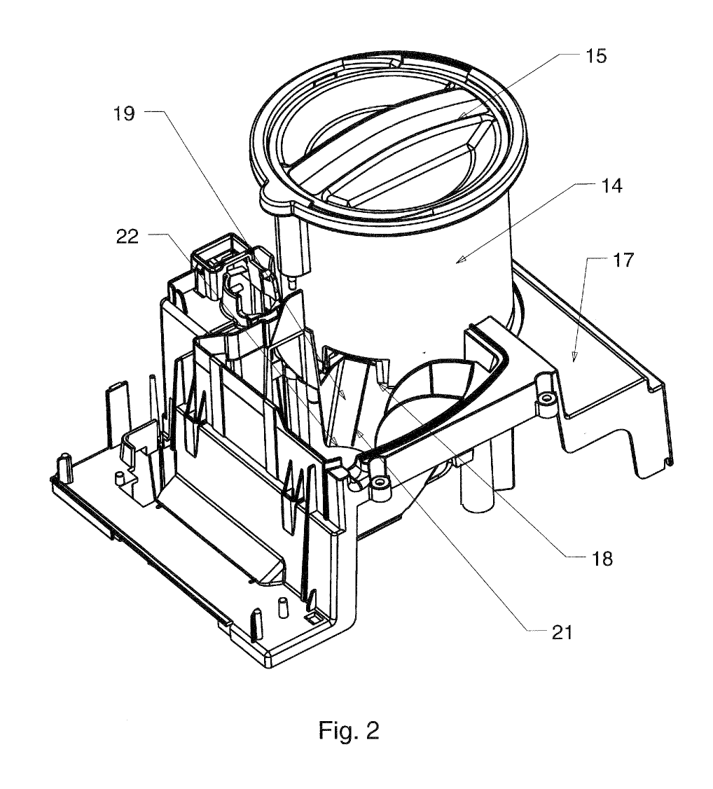

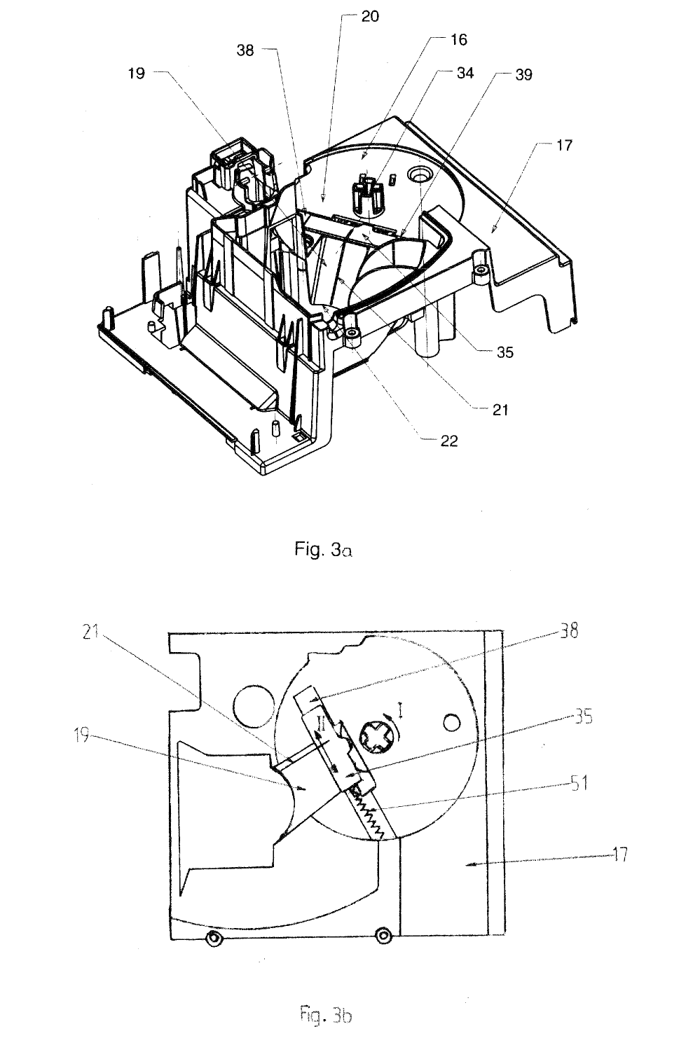

The appliance in addition comprises the dispenser 10 of product in granular form, which comprises, in the example represented and as is seen more clearly on FIG. 2, a reservoir 14 for ground coffee or coffee beans, of generally cylindrical form, closed by a removable lid 15, is mounted on a seat 17 located inside case 1 of the appliance and supported by the internal framework of the machine. Reservoir 14 can be installed in a removable manner in a base 16 (FIG. 3a) of seat 17, for example by a bayonet fastener. Reservoir 14 comprises at its bottom a plurality of rotatable radial blades, for example four blades, distributed around a hollow cylindrical body and driven about the vertical axis of reservoir 14 by a motor-reducer to transfer grounds towards the brewing chamber, via a dispensing opening 18 located at the lower part of reservoir 14, and a chute 19, as will be described in greater detail below. Such a reservoir 14 for grounds can for example be built exactly according to the description in the patent document FR 2 713 906, cited previously herein.

As is shown in FIGS. 2 and 3, chute 19 has the shape of a semi-cylindrical, or concave, channel that is tilted, or inclined, relative to the vertical, and which ends at an outlet, at the low end of chute 19, at a short distance (2-3 cm) above the inlet to the brewing chamber of the machine, the upper end of chute 19 being arranged on the outlet side of reservoir 14, just below dispensing opening 18 of the latter. Chute 19 can be made of a plastic, advantageously in one piece, or integral, with seat 17.

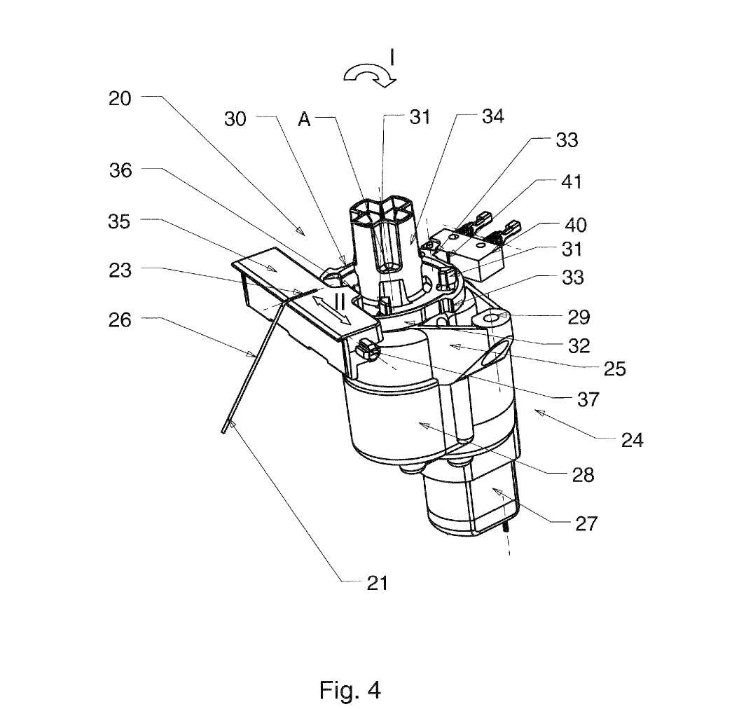

According to the invention, and as shown in FIGS. 3 and 4, the appliance includes an automatic device 20 for cleaning chute 19 along which granular product flows downwardly toward the brewing chamber. Automatic cleaning device 20 includes a wiping arm 21 adapted to sweep the semi-cylindrical wall 22 of chute 19 when it is placed into movement by a driving mechanism 25 that is driven mechanically by a motor-reducer 24.

As shown most clearly in FIG. 4, the driving mechanism 25 is driven in response to a rotational movement of an output shaft of motor-reducer 24 around a vertical axis A, in the sense depicted by the arrow I. Motor-reducer 24 is composed of a motor 27 and a speed reducing gear assembly 28. The rotational movement is produced by the vertical output shaft of motor 27, the rate of rotation being reduced by gear assembly 28 and device 25 being driven by the output of gear assembly 28. It will be readily apparent to those skilled in the art that gear assembly 28 can be given a number of different forms, based on knowledge existing in the art and depending on the motor output speed and the desired speed reduction ratio. Driving mechanism 25 comprises a rotatable cam member 30 having vertically protruding elements, or fingers, 31. During rotation of cam member 30 about axis A, each protruding element 31 comes, in turn, into contact with a boss 36 of a slider 35, as will be described in greater detail below.

The body of motor-reducer 24 is assembled in the lower part of seat 17 of the machine by fastening screws passing through fastening bores 29. Cam member 30 comprises a part 32 in the form of a disc supporting protruding fingers 31, extending from the horizontal base of disc 32. The part 32 in the form of a disc is prolonged vertically upwardly by a hub 34. As can be seen in FIG. 3, hub 34 of cam member 30 protrudes upwardly relative to seat 17 and passes upwardly through an opening located at the center of base 16 to arrive at the center of reservoir 14 when the latter is assembled on seat 17. Hub 34 in the shape of a cross comes to engage with dosing blades located inside reservoir 14 and drives the blades in rotation when motor-reducer 24 is placed into operation.

In addition, as shown in FIG. 4, the periphery of the part 32 in the form of a disc of cam member 30 is given the shape of a ratchet wheel by being provided with four radial protuberances 33. A switch 40, such as a microswitch of the lever or roller type, is placed near the periphery of cam member 30 so that each radial protuberance 33 actuates the movable contact 41 of switch 40 during rotation of cam member 30. Switch 40 is connected to an electronic circuit for counting the number of passages of protuberances 33 past contact 41, and thus the number of quarter revolutions carried out by cam member 30. The electronic circuit can be configured and programmed to control stopping of motor-reducer 24 and thus of cam member 30. The quantity of coffee grounds delivered by dispenser 10 is thus managed by the same cam member 30, the number of passages of radial protuberances 33 past switch contact 41 determining the quantity of ground coffee transferred onto chute 19.

Fingers 31 of cam member 30 are each disposed in proximity to a respective radial protuberances 33, but slightly shifted behind them in the direction of rotation of cam member 30 so that a cleaning cycle does not start immediately after the stopping of motor-reducer 24.

Fingers 31 of cam member 30 have the shape of right prisms, each having an attack, or forward, face that comes in contact with boss 36 of slider 35 when cam member 30 is rotating. Each forward face is oriented at an angle relative to an associated radius of cam member 30. Slider 35 has a generally parallelepipedic form and is assembled with play in a hollow housing 38 (shown in FIG. 3) of corresponding form, provided in seat 17. As shown in FIG. 3b, a return compression spring 51 is mounted to one of the ends of slider 35, being fixed more particularly at the level of its pin 37, the other end of the spring coming to abut inside housing 38. Alternatively, spring 51 could be replaced by a tension spring mounted at the end opposite to pin 37 and pin 37 would then act as an abutment. Slider 35 is arranged in housing 38 so as to be able to slide in the direction of arrow II of FIG. 4, the side walls 39 (FIG. 3a) of housing 38 forming guide rails for guiding the sliding motion of slider 35. The end of slider 35 opposed to that carrying pin 37 can also present an elastic abutment made, for example, of an elastomer material.

As is shown more clearly in FIG. 4, slider 35 carries wiping arm 21, which has a horizontal base 23 fixed to the center of the upper horizontal face of slider 35. Wiping arm 21 also comprises, as a prolongation of its base 23, an active part 26 having a length comparable to, or even slightly shorter than, the length of chute 19. Active part 26 of arm 21 is tilted, or inclined, relative to base 23 of the arm at an angle equal to the angle of inclination of chute 19 with respect to the horizontal. Wiping arm 21 consists of, or is based on, a stainless steel wire and is fixed to slider 35 so that active part 26 comes in contact with semi-cylindrical wall 22 of chute 19. Due to the elasticity of the steel wire and its assembly in contact with the chute, active part 26 of wiping arm 21 comes to bear elastically against wall 22 of chute 19.

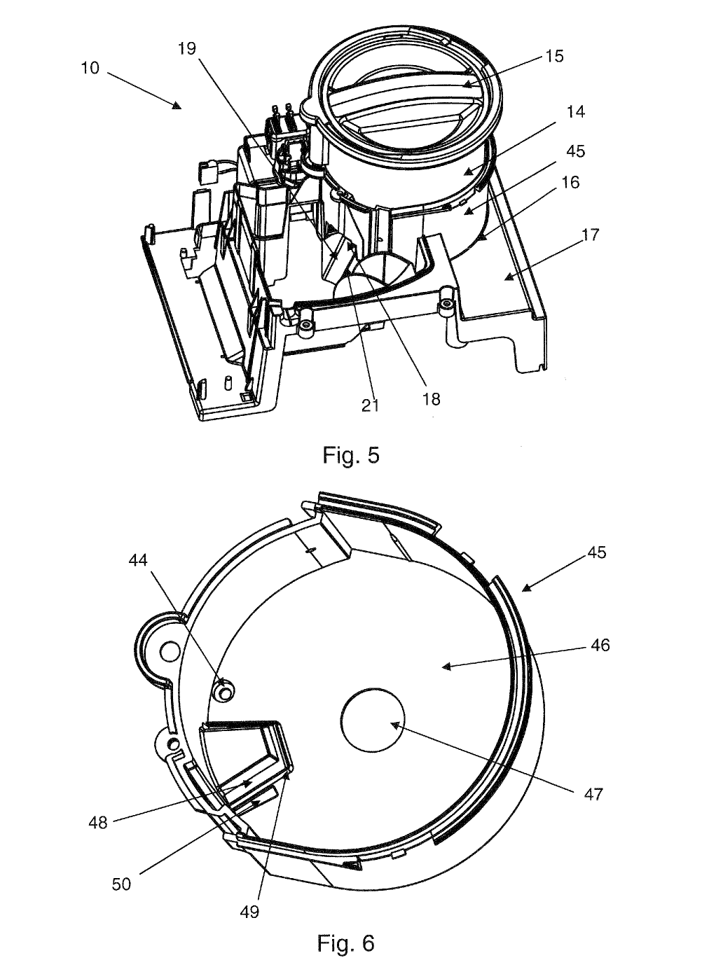

FIGS. 5 and 6 illustrate an alternative embodiment of dispenser 10 for product in granular form according to the invention where reservoir 14 for ground coffee is mounted removably in seat 17 inside case 1 of the appliance through the intermediary of a support 45. Support 45 is a part that is generally cylindrical and open at the top, having in the central part of its bottom wall 46 a circular opening 47 to receive hub 34. Support 45 is mounted with its base in base 16 of seat 17 and is secured in place with the aid of a fastening screw (not shown) that passes through an opening 44 in bottom wall 46. Bottom wall 46 also has an opening 48 cooperating with dispensing opening 18 of reservoir 14. Opening 48 presents a trapezoidal form that widens towards the periphery of support 45, a form similar to that of opening 18, as well as dimensions close to those of opening 18. The periphery of opening 48 presents an edge 49 that is elevated relative to the surface of bottom wall 46.

In an advantageous way according to this embodiment, support 45 presents a slot 50 adjacent to edge 49 of opening 48 and at the level of bottom wall 46 for evacuation of grounds that may have fallen onto wall 46. This slot 50 is formed in bottom wall 46, and has a form that is elongated in the radial direction and that is slightly widened towards the center of support 45 to increase the area of the opening for passage of grounds, while following, on one side, the inclination of opening 48. Slot 50 communicates with the underlying chute 19, the width of chute 19 being greater than that of opening 48 and the adjacent slot 50. Slot 50 is used to evacuate residual grounds that might escape from reservoir 14 and fall inside support 45. These grounds can swept by the user by using a brush (not shown, and which can be furnished with the appliance) after preliminary removal of reservoir 14. After sweeping, the grounds fall into chute 19 from where they can be removed by the wiping arm 21 when dispenser 10 is placed into operation, as will be described below.

In operation, by actuating one of buttons or switches 3, the user triggers a coffee brewing cycle. The brewing cycle starts with the dispensing of coffee grounds from reservoir 14 through chute 19 and into the brewing chamber, the actuation of button or switch 3 being effective to supply operating power to motor-reducer 24, which places cam member 30 into rotation. Hub 34 of cam member 30 drives the dosing blades inside reservoir 14 to push coffee grounds through dispensing opening 18. During its rotation, cam member 30 imparts a back and forth translatory movement to slider 35, as a result of the four fingers 31 coming successively into contact with boss 36 of slider 35. In effect, each finger 31 can push slider 35 in opposition to its return spring (which can be a compression or tension spring depending on its arrangement relative to the slider), the spring moving to its unstressed position as soon as finger 31 is no longer in contact with boss 36 to thus move the slider in the return direction.

The path or amplitude of movement of slider 35 corresponds to the width of dispensing opening 18, which is, itself, equal to the width of chute 19, so that the wiping arm 21 can sweep the entire width of chute 19. Thus, in the neutral, or rest, position of the return spring, wiping arm 21 carried by slider 35 is pushed laterally against a side of the wall of chute 19. During subsequent rotation of cam member 30, one of fingers 31 pushes boss 36 of slider 35 in the opposed direction, wiping arm 21 being then moved across chute 19 to the diametrically opposite position inside chute 19, from where arm 21 is brought back by the return spring to its initial, position. In the illustrated example, cam member 30 has four fingers 31, which allows four back and forth movements of wiping arm 21 per revolution of cam member 30.

In addition, while cam member 30 rotates, each radial protuberance 33 of cam member 30 actuates switch 40 to produce a pulse that is supplied to the electronic circuit, the pulses being processed to produce a count of the number of quarter turns carried out by cam member 30 and thus by hub 34 for driving the dosing blades of reservoir 14. As an example, the delivery of a ground coffee dose, or measured amount, through dispensing opening 18 can correspond to ¾ of a revolution of cam member 30 or to one full revolution of cam member 30. This then causes wiping arm 21 to carry out three or four back and forth movements for sweeping the chute during dispensing of a coffee dose toward the brewing chamber. Motor-reducer 24 is stopped as soon as the quantity of grounds necessary to carry out a brewing cycle has been dispensed.

Slider 35 thus carries out a back and forth movement, as indicated by double arrow II in FIG. 4, this movement being imparted to wiping arm 21, which thus carries out a sweeping of chute 19 in the direction of the width of chute 19 throughout the entire operation of motor-reducer 24 and thus for the entire period during which coffee is being dispensed along chute 19. This makes it possible, on the one hand, to avoid agglomeration of grounds in the chute at the time of the passage of the coffee grounds towards the brewing chamber and, on the other hand, to always keep the chute clean.

After the arrival of the grounds in the brewing chamber, the pressing piston is caused to descend in the brewing chamber to compress, or tamp, the grounds, which are then traversed by hot brewing water coming from the thermal block. The beverage then exits through tubes 5, the piston is raised to its initial position, the used “puck” is expelled into vat 9 and the appliance is ready to start a new brewing cycle.

Other alternatives and embodiments of the invention can be considered without leaving the framework of the claims.

Thus, the same device for automatic cleaning of the chute could be used with a coffee machine using a coffee bean mill or grinder in place of the ground coffee reservoir described above.

One could use, as an alternative, a cam comprising a different number of uniformly distributed fingers. In another alternative, one could consider a smaller number of fingers, for example only one finger carried by the cam member, but arranged so that the wiping arm carries out a sweeping only at the end of cycle of dispensing grounds into the chute (for example while using moreover means for returning the cam member to its initial position for each new brewing cycle). According to still another alternative, one could use a cleaning device dissociated from the grounds dispenser to immediately carry out a sweeping after the passage of coffee grounds along the chute and preferably before opening of the brewing chamber.

In addition, the wiping arm could be made in the form of a flexible plate, or blade, with an active part made of elastomer connected to a metal part for attachment to the slider.

One could use, according to another alternative, several wiping arms that are displaced in translation or pivotably, in the direction of the width of the chute or in the direction of its length.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it

is intended that such expressions be given their broadest interpretation.

What is claimed is:

1. An automatic dispenser for brewing beverages from a product in granular form, comprising:
a brewing chamber;
a device for dispensing the product in granular form, said device having a dispensing opening and a chute communicating with said dispensing opening, said chute being adapted to channel the product towards said brewing chamber; and
an automatic device for cleaning said chute, wherein said automatic device for cleaning said chute comprises a wiping arm disposed within said chute and an electric drive mechanism connected for imparting a cleaning movement to said wiping arm.

2. The dispenser of claim 1, wherein said electric drive mechanism comprises: an electric motor having a rotatable output shaft; and a driving mechanism coupled to said shaft and adapted to transform the rotary movement of said shaft into a reciprocating motion of said wiping arm.

3. The dispenser of claim 2, wherein said electric motor forms a component of said device for dispensing the product in granular form.

4. The dispenser of claim 3, wherein said drive mechanism comprises: a cam member; and a gear assembly coupled between said output shaft of said electric motor and said cam member for rotating said cam member.

5. The dispenser of claim 4, wherein said cam member is coupled to displace said wiping arm along, and in contact with, at least one wall of said chute.

6. The dispenser of claim 1, wherein said wiping arm is driven to carry out at least one back and forth movement during a phase of dispensing granular product.

7. The dispenser of claim 1, wherein said wiping arm is driven to carry out at least three back and forth movements during a phase of dispensing granular product.

8. The dispenser of claim 6, wherein said cam member is mounted to rotate around a vertical axis.

9. The dispenser of claim 4, further comprising a switch actuated by said cam member for controlling the operation of said device for dispensing the product in granular form.

10. The dispenser of claim 4, wherein said device for dispensing the product in granular form comprises a ground coffee reservoir containing a dosing device provided with blades, and said cam member has means for driving the blades of the dosing device in rotation.

11. The dispenser of claim 4, wherein said automatic device further comprises a slider to which said wiping arm is fixed, said slider being guided in translation in a plane perpendicular to the axis of rotation of said cam member.

12. The dispenser of claim 11, wherein said slider is mounted in a housing together with a return spring, said cam member is operative to displace said slider in a first direction and the return spring is operative to produce a force in a direction opposed to the first direction.

13. The dispenser of claim 11, wherein said chute is inclined relative to the plane in which said slider is guided, and said wiping arm is adapted to the inclination of said chute.

14. The dispenser of claim 1, wherein said chute has a width and said automatic device is operative to impart a translational movement to said wiping arm in the direction of the width of said chute.

15. The dispenser of claim 1, wherein said dispensing opening has a width, said wiping arm is disposed close to said dispensing opening and the cleaning movement imparted to said wiping arm has an amplitude appreciably equal to the width of said dispensing opening.

16. The dispenser of claim 1, wherein said wiping arm comprises a stainless steel wire.

17. The dispenser of claim 16, wherein said wiping arm is mounted to bear elastically against a wall of said chute.

18. The dispenser of claim 1, wherein said device for dispensing the product in granular form comprises a support provided with an opening for passage of the product in granular form towards said chute and a reservoir for storing the product, said reservoir being mounted removably on said support.

19. The dispenser of claim 18, wherein said support has a bottom wall provided with a slot for evacuation of product in granular form toward said chute.

20. The dispenser of claim 1, wherein said wiping arm is mounted to bear elastically against a wall of said chute.
